(19) United States
(12) Patent Application Publication
(10) Pub. No.: US 2010/0115566 A1
(43) Pub. Date: May 6, 2010

(54) Fast Channel Change Request Processing

(76) Inventor: Raziel Haimi-Cohen, Springfield, NJ (US)

Correspondence Address: RYAN, MASON & LEWIS, LLP, 90 FOREST AVENUE, LOCUST VALLEY, NY, 11560, US

(21) Appl. No.: 12/261,175

(22) Filed: Oct. 30, 2008

(51) Int. Cl. H04N 7/173

(52) U.S. Cl. 725/94

(57) ABSTRACT

A fast channel change request is processed in a signal distribution system comprising a network element coupled between a user interface device and a fast channel change server. The network element detects a fast channel change request sent from the user interface device for processing by the fast channel change server, and takes an action based on the detected fast channel change request. The action is effective to permit alteration of at least one characteristic of a unicast transmission that would otherwise be provided to the user interface device responsive to the fast channel change request.

### FIELD OF THE INVENTION

The present invention relates generally to signal distribution systems, and more particularly to techniques for processing fast channel change requests in such systems.

### BACKGROUND OF THE INVENTION

One example of a signal distribution system is a system providing Internet protocol television (IPTV) over digital subscriber line (DSL) or fiber. In such a system, a subscriber or other user is provided with an interface device, such as a set-top box (STB) or receiver, for communicating with network equipment, which may comprise a DSL access multiplexer (DSLAM). The interface device is configured to permit the subscriber to receive, on a television or other presentation device coupled to the interface device at a given location, a content stream corresponding to a selected channel.

In order to receive a given selected channel in an IPTV system, the interface device will typically join a corresponding multicast stream. This is problematic in that there can be a substantial delay, on the order of several seconds, between user entry of a channel change command and receipt of decodable multicast data for the new channel. The conventional approach to this problem is to deploy a fast channel change (FCC) server which caches the last few seconds of the content stream for each channel. Responsive to a channel change command, the interface device sends an FCC request to the FCC server. The FCC server then sends the interface device a short unicast stream for immediate playback, until the interface device “catches up” with the normal multicast stream for the new channel.

Additional details regarding an exemplary implementation of this conventional approach can be found in U.S. Patent Application Publication No. 2005/0081244, entitled “Fast Channel Change.”

Unfortunately, the conventional FCC server approach has a number of significant drawbacks. For example, the scalability of this solution is limited by the amount of data which needs to be sent for each FCC transaction, due to constraints on network bandwidth and FCC server output. The amount of data per FCC transaction is very sensitive to the variability of the multicast join time, that is, the time from sending a join request until receiving the first multicast packet. Also, there is a danger that too many concurrent FCC transactions could overload the backplane of the DSLAM, thus causing visual artifacts for all users, not only the ones engaged in channel change.

### SUMMARY OF THE INVENTION

The present invention in the illustrative embodiments provides improved techniques for fast channel change in an IPTV system or other type of signal distribution system.

In accordance with one aspect of the invention, an FCC request is processed in a signal distribution system comprising a network element coupled between a user interface device and an FCC server. The network element may be a DSLAM and the user interface device may be an STB. The network element detects an FCC request sent from the user interface device for processing by the FCC server, and takes an action based on the detected FCC request. The action is effective to permit alteration of at least one characteristic of a unicast transmission that would otherwise be provided to the user interface device responsive to the FCC request.

In one illustrative embodiment, the action taken by the network element comprises modifying the FCC request, and forwarding the modified FCC request to the FCC server. For example, the FCC request may be modified by inserting an available bandwidth indicator into a designated field in the FCC request. The FCC server utilizes the available bandwidth indicator to alter a burst factor, denting factor or other characteristic of a unicast transmission to the requesting user interface device. The available bandwidth indicator may comprise, for example, an indicator of a currently available bandwidth of a connection between the network element and the user interface device. As another example, the available bandwidth indicator may specify a bandwidth lower than a currently available bandwidth of a connection between the network element and the user interface device, so as to allow the network element to reduce its current processing load.

In another illustrative embodiment, the action taken by the network element comprises parsing the FCC request to identify a requested channel, and sending a multicast join request to join the network element to a multicast stream corresponding to the requested channel. The network element in this embodiment may modify the FCC request to indicate a corresponding reduction in an expected multicast join time for the user interface device, and forward the modified FCC request to the FCC server. The FCC server in turn adjusts one or more parameters of its unicast transmission to the requesting user interface device based on the reduction in expected multicast join time.

The illustrative embodiments advantageously facilitate the processing of FCC requests in an IPTV system or other type of signal distribution system. For example, the disclosed techniques increase the number of FCC requests which can be supported by a given FCC server, thereby reducing the costs associated with implementing a system having FCC functionality. Also, the disclosed techniques allow a network element such as a DSLAM to control the amount of unicast data that it must process responsive to FCC requests, which can help to avoid overloading of the DSLAM backplane.

### BRIEF DESCRIPTION OF THE DRAWINGS

FIG. 1 shows an illustrative embodiment of a signal distribution system in accordance with the invention.

FIG. 2 is a more detailed view of a portion of a signal distribution system in an illustrative embodiment.

FIG. 3 is a graphical plot illustrating the processing of a given FCC request by an FCC server in the FIG. 2 system.

FIGS. 4 and 5 are flow diagrams showing different types of FCC request processing techniques in the FIG. 2 system.

### DETAILED DESCRIPTION OF THE INVENTION

The invention will be described herein in conjunction with illustrative embodiments of signal distribution systems and associated FCC request processing techniques. It should be understood, however, that the invention is not limited to use with the particular systems and techniques described, but is instead more generally applicable to any signal distribution system in which it is desirable to provide improved handling of FCC requests. For example, although described herein primarily in the context of IPTV systems, the techniques of the invention can also be adapted in a straightforward manner to other types of signal distribution systems, including, for example, cellular systems.

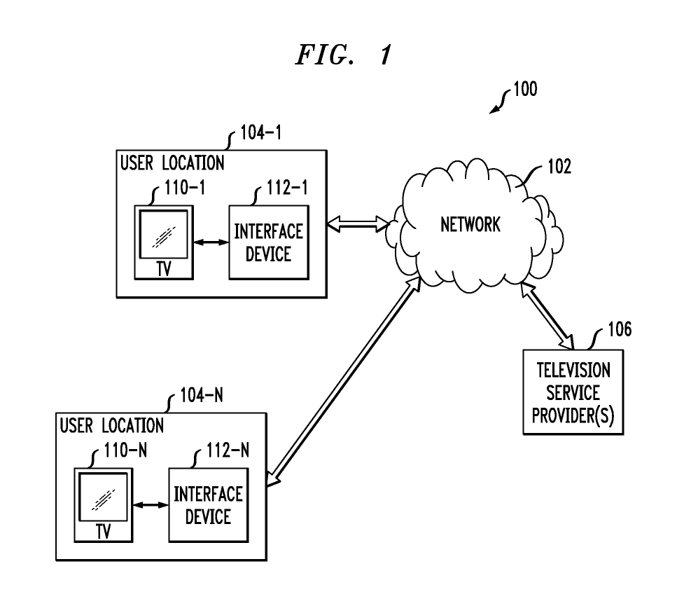

Referring now to FIG. 1, a signal distribution system 100 comprises a network 102 over which equipment at user locations 104-1 through 104-N communicates with one or more television service providers 106. The signal distribution system 100 may comprise, by way of example, an IPTV system. Element 106 may comprise otherwise conventional service provider equipment, including, for example, head end systems, satellites, servers, etc. The equipment at a given location 104-i, i=1, . . . N, comprises a television 110-i coupled to an interface device 112-i. The interface devices 112 for purposes of the illustrative embodiments will be assumed to be STBs, but in other embodiments may comprise, for example, receivers, computers, or other processor-based devices, in any combination. Such devices are also referred to herein as user interface devices or “clients.” A given device of this type allows one or more users to access content streams that are delivered to the device via other elements of the signal distribution system.

The network 102 may comprise any type of communication network suitable for transporting signals associated with the provision of television services, and the invention is not limited in this regard. For example, portions of the network 102 may comprise local networks, wide area networks, the Internet, etc.

It is to be appreciated that the invention does not require any particular geographic relationship between the various user locations 104. For example, the locations may all be within the same local area, served by a single common DSLAM. It is also possible that the different locations may be served by different DSLAMs. Numerous alternative arrangements are possible, as will be apparent to those skilled in the art.

A given one of the interface devices 112 may comprise, for example, a processor coupled to a memory. The processor may be implemented as a microprocessor, a microcontroller, an application-specific integrated circuit (ASIC) or other type of processing device, as well as portions or combinations of such devices. The processor may comprise a decoder for converting received content streams to a format suitable for presentation on television 110. The memory may include an electronic random access memory (RAM), a read-only memory (ROM) or other type of storage device, as well as portions or combinations of such devices. A portion of the memory may comprise an input buffer for storing content streams received from the television service provider 106. The processor and memory are used in storage and execution of one or more software programs for implementing interface device portions of the fast channel change processing techniques disclosed herein. The memory may be viewed as an example of what is also referred to herein as a computer-readable storage medium.

The particular signal distribution system configuration shown and described in conjunction with FIG. 1 should be viewed as an illustrative example of such a system, and it is to be understood that the invention can be implemented using other types and configurations of system components.

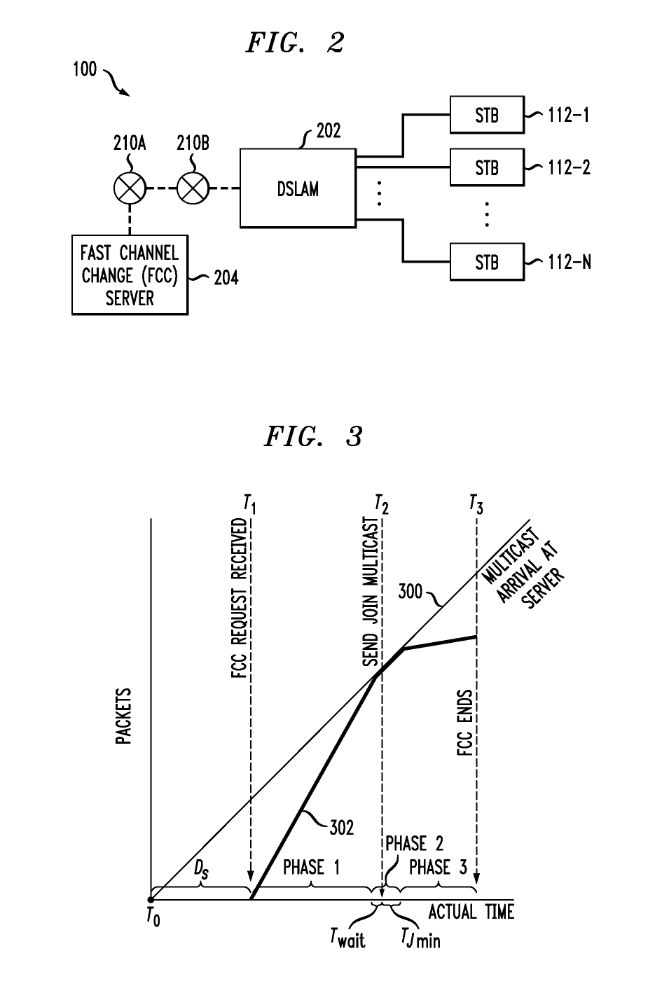

The present invention in an illustrative embodiment deals with processing of FCC requests in an IPTV system. Exemplary FCC request processing techniques will now be described in greater detail with reference to FIGS. 2 through 5. Again, it will be assumed for description of these illustrative embodiments that the interface device 112 is an STB, although other types of interface devices could be used.

FIG. 2 shows a more detailed view of one possible implementation of a portion of the system 100. In this embodiment, the network 102 comprises an IP network over which multiple streams are delivered to STBs 112 via a DSLAM 202. The corresponding televisions 110 are omitted from the figure for simplicity and clarity of illustration. The system 100 as shown further comprises an FCC server 204 which is coupled via a number of routers 210A and 210B to the DSLAM 202.

The FCC server 204 may be viewed as equipment associated with the television service provider(s) 106. Although shown as a separate, stand-alone device, the FCC server may be implemented on a common processing platform with one or more other servers of the system, or may be distributed across multiple such processing platforms.

The particular number of routers between the FCC server and the DSLAM may vary and therefore the connections between these elements are shown in dashed outline. Also, although the figure shows only a single DSLAM and a single FCC server, a given embodiment can of course include multiple such elements. The system 100 may further include additional elements of a type found in conventional implementations of such a system, such as switches, content servers, ad servers, etc.

The DSLAM 202 is an example of what is more generally referred to herein as a “network element.” In this embodiment, the DSLAM is a network element which is coupled between the STBs 112 and the FCC server 204. Therefore, every request for a fast channel change from the STBs goes through the DSLAM. In a conventional system, the DSLAM has a passive role in that it simply passes FCC requests from the STBs to the FCC server and delivers unicast streams from the FCC server to the STBs.

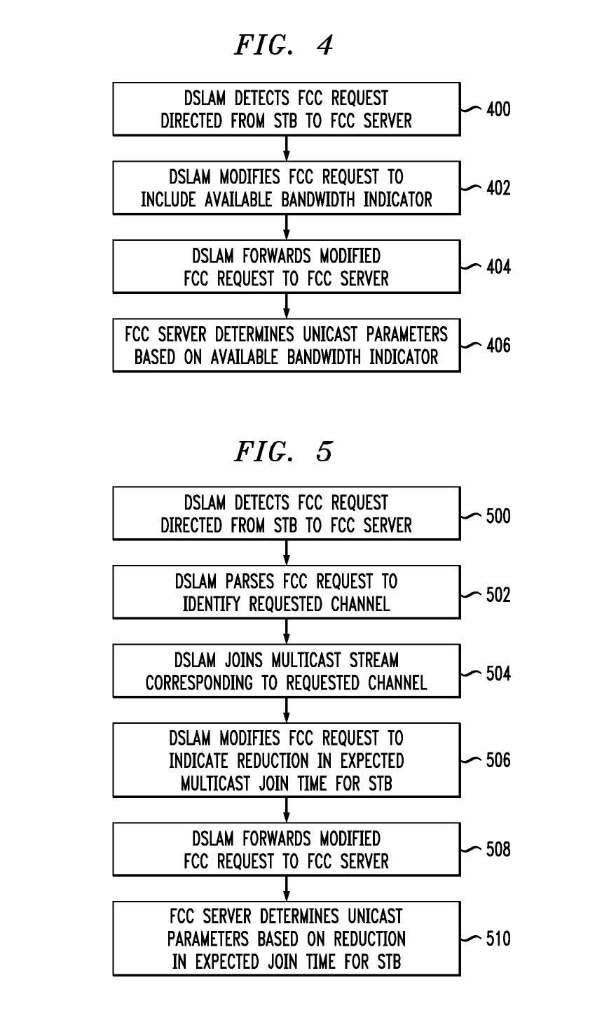

Illustrative embodiments of the invention actively involve the DSLAM in the processing of FCC requests in a manner that expedites FCC request handling and allows the FCC server to handle a larger volume of such requests. Examples of these FCC request processing techniques will be described below in conjunction with the flow diagrams of FIGS. 4 and 5. These techniques generally involve detecting FCC requests in the DSLAM, and taking actions in the DSLAM based on the detected requests. The actions that may be taken in the DSLAM include, for example, modifying the FCC requests to include available bandwidth indicators, or identifying the requested channel and having the DSLAM join the corresponding multicast group.

Before describing the techniques of FIGS. 4 and 5 which actively involve the DSLAM in the processing of FCC requests, the general handling of FCC requests by the FCC server will be described with reference to FIG. 3.

FIG. 3 illustrates the processing of an FCC request by the FCC server 204 in the system 100. This figure includes plots of incoming multicast packet arrival and outgoing unicast packet transmission associated with a given FCC request received at FCC server 204 from a given one of the STBs 112 via DSLAM 202.

Line 300 illustrates the arrival of multicast packets of a given content stream at the FCC server 204. These multicast packets arrive at the FCC server continuously. At any given point in time the FCC server has the last few seconds of multicast transmission cached, that is, stored in memory. The multicast packet arrival rate is assumed to be normalized to a value of 1 in the figure.

The FCC request is received by the FCC server 204 at time T₁. Responsive to receipt of the FCC request, the FCC server begins unicast packet transmission to the STB via the DSLAM. The packets sent by unicast are taken from the cache beginning with the packet received at time T₀. The difference D_{S} between T₁ and T₀ is the initial time gap between the incoming multicast packets and the outgoing unicast packets. Line 302 in the figure illustrates the transmission of unicast packets from the FCC server to the STB.

During the unicast transmission from the FCC server to the STB, an operation known as “denting” may optionally be applied. In a denting operation, the FCC server drops less important packets in order to more quickly close the time gap between the incoming multicast packets and the outgoing unicast packets. A denting factor F may be defined, where 0≦F<1, to represent the fraction of the multicast data which is dropped by the FCC server. A value of F=0 indicates no denting. Typically, denting is applied only to video portions of the content stream and is done on a video frame by video frame basis. The video frames are classified based on the visual impact that dropping a particular frame would have, and the video frames having the least visual impact are dropped first.

As one illustrative example, in a given group of pictures (GOP) of an MPEG-2 content stream, video frames are dropped based on their priority until the fraction of multicast data dropped reaches F. The first frames to be dropped are unreferenced frames. If not all the unreferenced frames need to be dropped, the dropped frames should be distributed evenly throughout the GOP. If dropping the unreferenced frames is not sufficient, referenced frames should be dropped too, beginning from those closest to the end of the GOP and moving backwards.

Denting is usually not applied to audio portions of the content stream, as this is more likely to produce objectionable artifacts and the resulting bandwidth gain would be negligible.

The unicast transmission from the FCC server to the requesting STB occurs in three phases between times T₁ and T₃ as shown. These phases are denoted in the figure as Phase 1, Phase 2 and Phase 3.

Phase 1 begins with the reception of the FCC request at time T₁. The rate during this phase is 1+E, where E is a burst factor (E≧0). As noted above, the normalized multicast packet arrival rate is 1. Thus, the unicast packet transmission rate in Phase 1 may be greater than the multicast packet arrival rate. This is possible because the packets sent during this phase are drawn from the cache. Typically E is selected so that 1+E is the available bandwidth for streaming data to the STB. During Phase 1 the time gap between the incoming multicast packets and the outgoing unicast packets is decreasing, either because the outgoing unicast transmission rate is greater than the incoming multicast transmission rate, or if E=0, because of the denting operation.

Phase 2 begins when the time gap between the incoming multicast packets and the outgoing unicast packets becomes zero. During this period, incoming packets are sent to the STB immediately, without any delay. The unicast packet transmission rate is therefore the same as the multicast packet arrival rate. After a wait time T_{wait} from the start of Phase 2, the FCC server instructs the STB to join the multicast stream at time T₂. Conventional signaling protocols, such as Internet group management protocol (IGMP), may be used to allow a given STB to join a multicast group that is receiving a particular content stream.

The wait time T_{wait} is associated with the denting operation. If no denting is used, T_{wait} should be set to 0.

There is a multicast joining delay of at least T_{Jmin} from the time T₂ at which the STB is instructed to join the multicast stream until the STB begins receiving multicast packets. During this period the FCC server does not have to share the available bandwidth with the multicast stream and hence it can continue sending unicast packets to the STB at rate 1. Typically T_{Jmin} will not be more than a few tens of milliseconds. If T_{Jmin} is set to zero, Phase 2 ends immediately after instructing the STB to join the multicast. Thus Phase 2 may be altogether eliminated if it is assumed that no denting is used and T_{Jmin}=0.

Phase 3 is a time period during which the STB may be receiving both the multicast stream at rate 1 and the unicast stream from the FCC server. During this period the unicast rate drops to E, thus the total bit rate of the multicast stream and the unicast stream from the FCC server does not exceed the available bandwidth of 1+E. Usually the duration of this phase is a few hundred milliseconds.

The initial time gap D_{S} is typically selected as the smallest value that satisfies two conditions. First, the initial unicast packet, corresponding to time T₀, needs to be an entry point, that is, a point from which the decoding of the content stream can be started. Until such an entry point is reached, the incoming data is not decodable by the STB. Second, D_{S} has to exceed a certain minimum, D_{Smin}, which is determined based on the available bandwidth 1+E and the variability in the multicast join time, namely the difference between the expected maximum and minimum of the interval T_{Jmin} from the time T₂ at which the STB is instructed to join the multicast stream until the STB begins receiving multicast packets. Smaller values of E and larger variability in multicast join time will cause D_{Smin} to become larger, thus making Phase 1 longer. Since Phase 1 is the longest phase and has the highest unicast data rate, smaller values of E or larger variability in multicast join time will make the whole FCC transaction longer and thus require sending of more data in unicast.

Additional analysis and examples will now be provided to further illustrate the manner in which the available bandwidth and the variability in multicast join time influence the duration of Phase 1 and the amount of unicast data which is sent in that phase. For clarity of illustration, the following simplifying assumptions are made:

1. Denting is not performed.

2. The multicast data rate is constant over time.

3. Once the STB joins the multicast, each multicast packet arrives at the STB and at the FCC server at the same time.

4. The transmission delay of the unicast from the FCC server to the STB is negligible and ignored.

5. Processing times at the FCC server and at the STB are negligible and ignored.

6. The STB begins decoding the new channel immediately when it receives the first unicast packet from the FCC server.

7. The interval between entry points in the multicast stream is a constant, denoted G.

Let D₁ and B₁ be the duration and the amount of data sent in Phase 1, respectively. Since the data rate is normalized so that the multicast data rate is one, B₁ is given in time units and represents the amount of data transmitted by the multicast in that length of time. Phase 1 begins with an initial time gap of D_{S} and ends when the time gap decreases to zero. Since during this phase the FCC server sends data at rate 1+E and receives data at rate 1, D₁ and B₁ may be written as follows:

D₁=D_{S}/E (1)

B₁=D₁(1+E)=D_{S}(1+E)/E (2)

The STB begins at time T₁ to decode the unicast data corresponding to the multicast at time T₀, and since the STB decodes the data at rate 1, it constantly decodes data which is D_{S} behind the multicast at a given point in time. Therefore, when Phase 1 ends and the unicast catches up with the multicast, the STB has accumulated a buffer of size D_{S}. This buffer is maintained at the same level during Phase 2, during which the input rate equals the output rate. However, during Phase 3 unicast data arrives at rate E but is decoded by the STB at rate 1. Therefore, assuming 0<E<1, the buffer in the STB will be depleted D_{S}/(1−E) after the beginning of Phase 3 and the unicast packet decoded when the buffer is depleted corresponds to the multicast packet of D_{S} before, that is, the multicast packet received by the server D_{S}/(1−E)−D_{S}=D_{S}E/(1−E) after the beginning of Phase 3. For a seamless transition from the unicast stream to the multicast stream at the STB the multicast joining should be completed (i.e., the first multicast packet should be received) no later than D_{S}E/(1−E) after the beginning of Phase 3.

Let T_{Jmax} be the maximum time need to complete a multicast join and V=T_{Jmax}−T_{Jmin} be the variability or range of the multicast join time. Since Phase 3 begins T_{Jmin} after the STB starts joining the multicast, it is necessary for a seamless transition that V≦D_{S}E/(1−E). Therefore

D_{Smin}=V(1−E)/E (3)

As indicated previously, T₀ must be an entry point such that D_{S}≧D_{Smin}. Since the time T₁ at which the FCC request is received is random with respect to the position of the entry points in the video stream and since the entry points are G apart, on average

D_{S}=D_{Smin}+0.5 G=V(1−E)/E+0.5 G (4)

The table below shows values of D₁ and B₁ for several combinations of values of E and V, assuming that G=0.5 seconds. The first three rows of the table show the dramatic effect of increasing E from 0.1 to 0.3, while keeping V constant at 0.2 seconds. The last two rows of the table show a similar dramatic effect when E is held constant at 0.1 but V is reduced to 0.05 and 0.02 seconds.

| V | | D_{Smin} | D_{S} | D₁ | B₁ |
|---|---|---|---|---|---|
| Sec. | E | Sec. | Sec. | Sec. | Sec. |
| 0.20 | 0.10 | 1.80 | 2.05 | 20.50 | 22.55 |
| 0.20 | 0.20 | 0.80 | 1.05 | 5.25 | 6.30 |
| 0.20 | 0.30 | 0.47 | 0.72 | 2.39 | 3.11 |
| 0.05 | 0.10 | 0.45 | 0.70 | 7.00 | 7.70 |
| 0.02 | 0.10 | 0.18 | 0.43 | 4.3 | 4.73 |

It should be understood that these particular examples and the corresponding assumptions described above are not limitations of the present invention. For example, in other embodiments, the assumptions made above need not apply. Also, the particular phases, parameters and other characteristics of the FCC processing as illustrated in FIG. 3 may be varied in alternative embodiments.

As one possible further example, if no denting is used and T_{wait}=0, one may attempt to shorten or even eliminate Phase 2 by instructing the STB to join the multicast stream before the gap between the incoming multicast packets and the outgoing unicast packets is closed. However, such an arrangement is expected to result in only a small performance gain. It will also result in increased complexity, as the FCC server will need to predict when the gap is going to be closed and make sure that it happens not more than T_{Jmin} after the instruction to join the multicast stream is sent. In short time intervals such as T_{Jmin} this requires taking into account effects such as network jitter and variations in instantaneous bit rate, which make accurate prediction difficult.

Referring now to FIG. 4, an FCC request processing technique is shown in which DSLAM 202 intercepts and modifies FCC requests received from an STB 112 prior to forwarding such requests to the FCC server 204. As will be described, the DSLAM in this embodiment modifies a given FCC request to include an indicator of available bandwidth between the DSLAM and the requesting STB, such that the FCC server can use the indicator to optimize the amount of unicast data sent to the STB.

In step 400, the DSLAM 202 detects an FCC request directed from the STB 112 to the FCC server 204. This detection may involve, for example, identifying the FCC request as a message having a predetermined format, such as a packet encapsulated utilizing Internet Protocol (IP), User Datagram Protocol (UDP) and RTP Control Protocol (RTCP) with the RTCP message being of a particular type. RTCP is described in IETF RFC 3550 as a companion protocol for Real-time Transport Protocol (RTP). It is to be appreciated, however, that use of these or other particular protocols are not requirements of the invention, and other protocols such as Real-Time Streaming Protocol (RTSP) may be used in a given embodiment. As another example, the detection of an FCC request may involve identifying the FCC request as a message having as its destination address an address of the FCC server. Other types of detection techniques may be used.

The FCC request detected in step 400 need not be directed to a particular FCC server. More generally, the FCC request may be sent from the STB for processing by an FCC server, with no particular FCC server being identified in or otherwise associated with the request. References herein to FCC requests sent from an STB for processing by an FCC server should therefore not be construed as requiring processing by any particular FCC server. As mentioned previously, a given embodiment of the system may comprise multiple FCC servers.

In step 402, the DSLAM 202 modifies the FCC request to include an indicator of the available bandwidth of a connection between the DSLAM and the requesting STB 112. The available bandwidth indicator may indicate, for example, a currently available bandwidth of the connection between the DSLAM and the requesting STB. This information is readily available in the DSLAM, and generally indicates the link bandwidth that is available for unicast transmission between the DSLAM and the STB. The DSLAM may modify the FCC request by, for example, writing or otherwise inserting the available bandwidth indicator into a designated field or fields in the FCC request.

The available bandwidth indicator need not take any particular form, and may comprise, for example, a binary indicator of one of a plurality of possible levels of available bandwidth. Alternatively, the bandwidth indicator may comprise multiple parameters, for example, one parameter may specify the bandwidth discussed above and another parameter may specify a peak bandwidth for short duration bursts, which may be greater than the usual, long term bandwidth. Often a portion of the total bandwidth is allocated to non real time applications such as Internet browsing and thus is not available for IPTV streaming. However, the IPTV application may be allowed to briefly “steal” this portion of the bandwidth as long as on average the non real time applications get their allocated share. This “stealing” provides for a peak bandwidth greater than the average bandwidth. Other possible parameters that may be specified in the bandwidth indicator include, for example, the maximal allowed duration of the FCC transaction or the maximal amount of data which may be sent during the transaction.

In step 404, the DSLAM 202 forwards the modified FCC request to the FCC server 204. Thus, in this embodiment, the modified FCC request is sent to the same FCC server to which the original FCC request was directed. In other embodiments, the DSLAM may redirect the modified FCC request to a different FCC server.

In step 406, the FCC server 204 determines one or more unicast parameters based on the available bandwidth indicator in the modified FCC request. For example, the FCC server can determine the burst factor E based on the currently available bandwidth as reflected in the indicator. Other unicast parameters such as the initial time gap D_{S} and the denting factor F may also or alternatively be determined.

A number of more detailed examples will now be described to illustrate the manner in which the FCC server 204 may determine one or more unicast parameters from the available bandwidth indicator in step 406.

Let W denote the available bandwidth indicated by the available bandwidth indicator, normalized with respect to the multicast bit rate, e.g., if the multicast bit rate is 4 megabits/second and the available bandwidth is 5 megabits/second then W=1.2. Therefore, using the normalized data rate units which were used in the previous description of FIG. 3, the maximum burst factor which does not cause the data rate in Phase 1 to exceed the available bandwidth is 1−W. Thus the FCC server 204 may set E=1−W.

It should be noted that in the absence of the STB-specific information provided by the available bandwidth indicator, the FCC server 204 would generally have to assume a default low bandwidth value which would be adequate for all STBs. This would result in D₁ and B₁ being large for all FCC transactions, making all of them long and costly, even though many of the STBs could handle larger values of E. By using the information provided in the available bandwidth indicator, the value of E is set to the maximum allowed value for each specific requesting STB, yielding a potentially large reduction in the average duration and cost of FCC transactions.

The FCC server may use the information provided by the available bandwidth indicator in numerous other ways. The following are three additional examples which illustrate how this indicator may be used in determining unicast parameters:

1. There may be a restriction on the maximal delay D_{S} between the multicast and the decoding and presentation of the video on a display. If the calculated value of D_{S} exceeds the limit, one may turn on denting during Phase 3. As a result the parameter E in the formula for D_{S} (equation 4) should be replaced by E′=E/(1−F′), where F′ is the denting factor during Phase 3. The larger F′ is, the larger E′ becomes, resulting in a smaller value of D_{S}. The denting factor F′ may be set to the minimal value which yields an acceptable value of D_{S}.

2. The value D₁ or B₁, as calculated according to equations 1 and 2, may be unacceptably large. Since according to those equations, D₁ and B₁ are proportional to D_{S}, the FCC server can reduce D₁ or B₁ by turning on denting in Phase 3 and thus causing D_{S} to decrease. Alternatively or in addition to this measure, the FCC server can turn on denting in Phase 1. As a result the parameter E in the formulas for D₁ and B₁ (equations 1 and 2) should be replaced by E″=(1+E)/(1−F″), where F″ is the denting factor during Phase 1. The larger F″ is, the larger E″ becomes, resulting in smaller values of D₁ and B₁.

3. If the available bandwidth indicator includes a peak bandwidth parameter which is greater than the long term bandwidth parameter, let Wₚₑₐₖ be the normalized peak bandwidth. Since Phase 3 is relatively short, the FCC server can use during this phase a larger burst factor based on the peak bandwidth, E=1−Wₚₑₐₖ. This will result in smaller values of D_{Smin} and D_{S}, thus yielding lower values of D₁ and B₁. This technique may be used alone or in combination with one or more of the techniques described in the previous examples.

After the FCC server has determined one or more unicast parameters based on the available bandwidth indicator in the manner described above, the server provides a unicast transmission to the requesting STB 112 using the determined unicast parameter(s).

The DSLAM 202 in the FIG. 4 embodiment is therefore configured to intercept and modify an FCC request such that the modified request includes an indicator of an available bandwidth between the DSLAM and the requesting STB. This allows the FCC server that receives the modified request to more accurately establish an appropriate unicast transmission for conveying unicast packets of the requested channel to the STB. Generally, the greater the available bandwidth of the connection between the DSLAM and the requesting STB, the less unicast data the FCC server needs to send to that STB. Also, the available bandwidth can change from STB to STB (e.g., based on the length of the DSL line between the DSLAM and the STB) and dynamically over time (e.g., if the same DSL line serves multiple STBs). The FIG. 4 embodiment allows the FCC server to adapt its unicast transmissions to variations in available bandwidth between the DSLAM and the STBs. This will increase the number of FCC requests which the FCC server can support, which reduces the costs associated with implementing a system having FCC functionality. For example, in a given implementation the number of FCC servers required may be reduced.

It should be noted that the available bandwidth indicator need not indicate the currently available bandwidth. For example, at a given point in time the DSLAM 202 may be handling a large number of FCC requests, such that the backplane processing load on the DSLAM is high. In such a situation, the DSLAM may set the available bandwidth indicator in a given modified FCC request to specify a bandwidth that is lower than a currently available bandwidth of the connection between the DSLAM and the requesting STB. The DSLAM can take similar actions for the FCC requests received from other STBs. This helps to reduce the load on the DSLAM backplane by reducing the amount of unicast data that the DSLAM has to process responsive to the FCC requests. A similar advantageous result can be achieved by other arrangements in which the available bandwidth indicator is determined as a function of a current processing load of the DSLAM.

Also, the DSLAM could be configured to communicate information indicative of its current processing load to one or more FCC servers. For example, if the load on the DSLAM backplane is high, the DSLAM can indicate this condition to the FCC servers which are presently sending unicast data to it, by sending a message to each such FCC server. In response, the FCC servers could reduce their unicast data rate to those STBs which are connected to that DSLAM, for example, by reducing the burst factor or by increasing the dent factor.

Since the processing capacity of the DSLAM backplane is limited, reducing the amount of unicast data per FCC transaction will increase the number of FCC transactions which the DSLAM can handle.

If the DSLAM 202 has reached the limits of its processing capacity, it can block any further FCC requests until the condition subsides. This would force those STBs for which FCC requests have been blocked into a slow channel change mode, in which the STBs simply join multicast groups for their respective requested channels and wait for the multicast packets to arrive. Such a feature advantageously protects the DSLAM from overflow resulting from a surge in FCC requests.

FIG. 5 shows another FCC request processing technique. In this technique, the DSLAM 202 intercepts FCC requests received from the STB 112, parses the request to determine the requested channel, and joins the multicast stream corresponding to the requested channel. This technique is referred to herein as an “early join” of multicast by the DSLAM. This assumes, of course, that the DSLAM is not already part of the multicast group for the requested channel. If the DSLAM is already part of the multicast group for the requested channel, there is no need for an early join.

In step 500, the DSLAM 202 detects an FCC request directed from the STB 112 to the FCC server 204. As in the FIG. 4 embodiment, this detection may involve, for example, identifying a given message as an FCC request based on a predetermined message format or a destination address. Also, as noted above, the FCC request detected in step 500 need not be directed to a particular FCC server. More generally, the FCC request may be sent from the STB for processing by an FCC server, with no particular FCC server being identified in or otherwise associated with the request.

In step 502, the DSLAM 202 parses the FCC request to identify the particular requested channel specified therein.

In step 504, the DSLAM 202 joins the multicast stream corresponding to the requested channel. This may be accomplished by the DSLAM immediately sending a multicast join request for that multicast stream, without waiting for the STB to first send a multicast join request to the DSLAM. As a result, when the STB later sends its multicast join request, the DSLAM will already be receiving the multicast packets of the requested channel, so that the multicast join time for the STB will be very short.

In step 506, the DSLAM 202 modifies the FCC request to indicate a reduction in an expected multicast join time for the requesting STB 112. A major component of the multicast join time variability is the uncertainty as to whether the DSLAM is already receiving the multicast packets of the requested channel or whether it needs to first join the multicast group of the channel. Also, one does not know through how many routers the multicast join request will have to travel before it reaches one which is already a member of the requested multicast group. If the DSLAM happens to be a member of the requested multicast group, the join time is very close to T_{Jmin}. This uncertainty is eliminated in the present embodiment by the DSLAM automatically joining the multicast group of the requested channel in step 504.

Accordingly, the DSLAM in step 506 provides an indication of the reduction in expected join time variability to the FCC server. This indication need not take any particular form. For example, a simple binary indicator could be used to convey to the FCC server that the DSLAM is already a member of the multicast group for the requested channel. The DSLAM may insert the indicator into a designated field in the modified FCC request.

In step 508, the DSLAM 202 forwards the modified FCC request containing the indication of a reduction in expected join time to the FCC server 204.

In step 510, the FCC server 204 determines one or more unicast parameters based on the reduction in expected join time for the STB, as conveyed by the DSLAM in the modified FCC request. For example, the FCC server can take the reduction in expected join time into account in computing the initial time gap D_{S} using equations (3) and (4) above. This reduces the duration of the FCC transaction and the amount of unicast data that the FCC server needs to transmit. As in the FIG. 4 embodiment, this will increase the number of FCC requests which the FCC server can support, thus reducing the costs associated with implementing a system having FCC functionality.

The techniques disclosed in FIGS. 4 and 5 may be used separately, or both may be used together in a given implementation.

The particular process steps shown in FIGS. 4 and 5 are presented by way of illustrative example only, and other process steps may be used in other embodiments. For example, the FCC requests in the embodiments of FIGS. 4 and 5 are directed by the STBs to an FCC server via a DSLAM. Alternative embodiments may configure the DSLAM to serve as a proxy for the FCC server. The STBs then send their FCC requests to the DSLAM which modifies the requests in the manner described above prior to forwarding them to an FCC server. Also, although the processes of FIGS. 4 and 5 are described with operations performed in a DSLAM, these operations in other embodiments could be performed in other network elements, such as one of the routers 210.

The FCC request processing techniques described herein may be implemented at least in part in the form of software that is executed by network elements such as the DSLAM 202 and FCC server 204. Again, although illustrated in the context of IPTV, the described services can be adapted in a straightforward manner for use in other types of signal distribution systems, such as cellular systems, cable and satellite television systems, etc. As one example, the FCC request processing functionality associated with the DSLAM in the illustrative embodiments may be implemented, for example, in a base station of a cellular system which delivers television signals to mobile devices.

It should again be emphasized that the above-described embodiments of the invention are intended to be illustrative only. Numerous other alternative embodiments within the scope of the following claims will be readily apparent to those skilled in the art.

We claim:

1. A method of processing a fast channel change request in a signal distribution system, the system comprising a network element coupled between a user interface device and a fast channel change server, the method comprising the steps of:
detecting in the network element a fast channel change request sent from the user interface device for processing by the fast channel change server; and
taking an action in the network element based on the detected fast channel change request;
wherein the action is effective to permit alteration of at least one characteristic of a unicast transmission that would otherwise be provided to the user interface device responsive to the fast channel change request.

2. The method of claim 1 wherein the step of detecting the fast channel change request comprises identifying the fast channel change request as a message having a predetermined format.

3. The method of claim 1 wherein the step of detecting the fast channel change request comprises identifying the fast channel change request as a message having as its destination address an address of the fast channel change server.

4. The method of claim 1 wherein the step of taking an action in the network element comprises the steps of:
modifying the fast channel change request in the network element; and
forwarding the modified fast channel change request to the fast channel change server.

5. The method of claim 4 wherein the step of modifying the fast channel change request comprises inserting into a designated field in the fast channel change request an available bandwidth indicator that specifies a currently available bandwidth of a connection between the network element and the user interface device.

6. The method of claim 4 wherein the step of modifying the fast channel change request comprises inserting into a designated field in the fast channel change request an available bandwidth indicator that specifies a bandwidth lower than a currently available bandwidth of a connection between the network element and the user interface device.

7. The method of claim 4 wherein the step of modifying the fast channel change request further comprises inserting into a designated field in the fast channel change request an available bandwidth indicator that is determined as a function of a current processing load of the network element.

8. The method of claim 1 wherein the step of taking an action further comprises communicating information indicative of a current processing load of the network element to the fast channel change server.

9. The method of claim 1 wherein the step of taking an action in the network element comprises the steps of:
parsing the fast channel change request to identify a requested channel;
sending a multicast join request to join the network element to a multicast stream corresponding to the requested channel.

10. The method of claim 9 further comprising the steps of:
modifying the fast channel change request to indicate a reduction in an expected multicast join time for the user interface device; and
forwarding the modified fast channel change request to the fast channel change server.

11. The method of claim 1 wherein the step of taking an action in the network element comprises blocking the fast channel change request such that said request is not delivered to the fast channel change server.

12. The method of claim 1 wherein the step of taking an action in the network element comprises redirecting the fast channel change request to a different fast channel change server.

13. A processor-readable storage medium comprising executable program code that when executed in the network element implements the steps of the method of claim 1.

14. An apparatus for processing a fast channel change request in a signal distribution system, the apparatus comprising:
a network element coupled between a user interface device of the system and a fast channel change server of the system;
wherein the network element is configured to detect a fast channel change request sent from the user interface device for processing by the fast channel change server, and to take an action based on the detected fast channel change request;
wherein the action is effective to permit alteration of at least one characteristic of a unicast transmission that would otherwise be provided to the user interface device responsive to the fast channel change request.

15. The apparatus of claim 14 wherein the network element is configured to modify the fast channel change request prior to forwarding the modified fast channel change request to the fast channel change server.

16. The apparatus of claim 15 wherein the network element is configured to modify the fast channel change request by writing into a designated field in the fast channel change request an available bandwidth indicator that characterizes a connection between the network element and the user interface device.

17. The apparatus of claim 14 wherein the network element is configured to parse the fast channel change request to identify a requested channel and to send a multicast join request to join the network element to a multicast stream corresponding to the requested channel.

18. The apparatus of claim 17 wherein the network element is configured to modify the fast channel change request to indicate a reduction in an expected multicast join time for the user interface device prior to forwarding the modified fast channel change request to the fast channel change server.

19. The apparatus of claim 14 wherein the network element comprises one of a DSLAM and a router.

20. An apparatus for processing a fast channel change request in a signal distribution system, the apparatus comprising:
a fast channel change server configured to communicate with a user interface device of the system via a network element of the system;
wherein the fast channel change server is configured to receive from the network element a fast channel change request sent from the user interface device and modified by the network element;
the modified fast channel change request comprising an indicator inserted therein by the network element;
wherein the fast channel change server is further configured to provide a unicast transmission to the user interface device;
the unicast transmission having at least one characteristic that is determined based on the indicator.

21. The apparatus of claim 20 wherein the indicator comprises at least one of an available bandwidth indicator and a join time reduction indicator.
